(19) United States
(12) Patent Application Publication
(10) Pub. No.: US 2012/0151300 A1
(43) Pub. Date: Jun. 14, 2012

(54) Error Correcting

(76) Inventor: John E. Tillema, Fort Collins, CO (US)

(21) Appl. No.: 13/386,359

(22) PCT Filed: Aug. 25, 2009
(86) PCT No.: PCT/US09/54843

§ 371 Date: Jan. 20, 2012

(51) Int. Cl. G06F 11/10

(52) U.S. Cl. 714/768; 714/E11.043

(57) ABSTRACT

An example apparatus has an interface to a first memory and to a second memory. The example apparatus also has a control logic that functions to control the interface. The control logic can control the interface to write a data word to the first memory and to write an error checking and correcting (ECC) word associated with the data word to the second memory.

### BACKGROUND

Protecting memory using an error correcting code (ECC) involves processing error check words and data to determine whether and how to fix data words. Conventionally, ECC words have been stored in special ECC memory modules.

### BRIEF DESCRIPTION OF THE DRAWINGS

The accompanying drawings illustrate various example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa.

FIG. 1 illustrates an embodiment that includes a control logic operably connected to an interface that is in turn operably connected to two memories.

FIG. 2 illustrates an embodiment that includes a control logic and a fetch logic operably connected to an interface that is in turn operably connected to two memories.

FIG. 3 illustrates an embodiment that includes an ECC logic connected to a control logic and a fetch logic that are operably connected to an interface that is in turn operably connected to two memories.

FIG. 4 illustrates an embodiment that is implemented in a memory controller.

FIG. 5 illustrates an embodiment of a method associated with writing a data word and an ECC word associated with the data word to separate memories.

FIG. 6 illustrates an embodiment of a method associated with controlling an ECC word size and with writing a data word and an ECC word associated with the data word to separate memories.

FIG. 7 illustrates an embodiment of a method associated with controlling an ECC word size, with writing a data word and an ECC word associated with the data word to separate memories, and with retrieving a data word and a related ECC word from separate memories.

FIG. 8 illustrates an embodiment of a computing environment in which example apparatus and methods associated with writing a data word and an associated error checking and correcting word to separate memories may operate.

FIG. 9 illustrates an embodiment of two memories and a memory controller.

FIG. 10 illustrates an embodiment of two memories and a memory controller using non-ECC dual inline memory modules (DIMMs).

FIG. 11 illustrates an embodiment of two memories and a memory controller using ECC DIMMs.

### DEFINITIONS

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, element or limitation. Furthermore, repeated use of the phrase “in one embodiment” does not necessarily refer to the same embodiment.

ASIC: application specific integrated circuit.

CD: compact disk.

CD-R: CD recordable.

CD-RW: CD rewriteable.

DIMM: dual in-line memory module. Use of the term DIMM is to be interpreted to include “memory modules” of any variety.

DVD: digital versatile disk and/or digital video disk.

ECC: Error Correcting Code.

LAN: local area network.

NVRAM: non-volatile random access memory.

PCI: peripheral component interconnect.

PCIE: PCI express.

RAM: random access memory.

DRAM: dynamic RAM.

SRAM: static RAM.

ROM: read only memory.

PROM: programmable ROM.

EPROM: erasable PROM.

EEPROM: electrically erasable PROM.

USB: universal serial bus.

WAN: wide area network.

“Computer component”, as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Logic”, as used herein, includes but is not limited to hardware, firmware, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, and so on. Logic may include one or more gates, combinations of gates, or other circuit components. Where multiple logical logics are described, it may be possible to incorporate the multiple logical logics into one physical logic. Similarly, where a single logic element is described, it may be possible to distribute that single logical element between multiple physical elements.

### DETAILED DESCRIPTION

Example embodiments facilitate writing a data word and an associated error correcting code (ECC) word to different memories. One embodiment describes an apparatus that includes an interface to a first memory and to a second memory. The first memory and second memory may be standard memories instead of special ECC memories. Thus, neither the first memory nor the second memory may provide native support for ECC. However, example embodiments may still operate with memories that do provide native support for ECC. The apparatus also includes a control logic that functions to control the interface to write a data word to the first memory and to write an ECC word associated with the data word to the second memory. Since two memories are being written, the data word and its related ECC word may be written at substantially the same time. Since the data word and its related ECC word reside in different memories, a data word and its related ECC word may also be retrieved substantially simultaneously. In one embodiment, the two memories may be located in two separate physical memories while in another embodiment the two memories may be located in two separate logical memories that are physically located in the same physical memory (e.g., memory module, memory chip). In another embodiment, the ECC memory and the data memory may be intermixed across one or more physical memories. While two memories are described, one of ordinary skill in the art will appreciate that a greater number of memories may be employed.

Another embodiment describes a method. The method includes computing, in a hardware circuit, an ECC word associated with a data word. The method also includes writing the data word to a first memory and writing the ECC word to a second, potentially different, memory. The method may also include controlling an ECC word size, controlling how an ECC word is computed, and controlling how an ECC word is evaluated. The method may also include retrieving a data word and a related ECC word. In one example, both the data word and the ECC word may be written substantially in parallel. Once again, while two memories are described, one skilled in the art will appreciate that a greater number of memories may be employed.

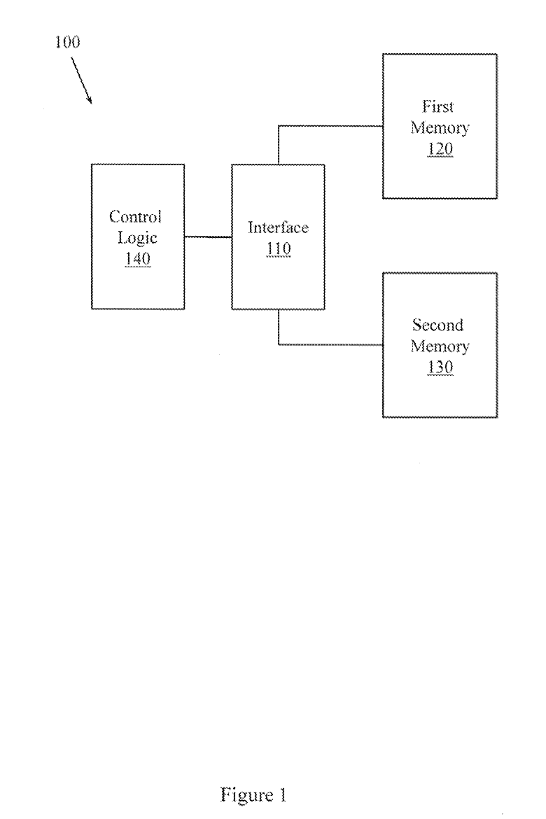

FIG. 1 illustrates an apparatus 100. Apparatus 100 includes an interface 110 that is operably connected to a first memory 120 and to a second memory 130. The first memory 120 may be, for example, a RAM, a NVRAM, a DIMM, or other type of memory. The first memory 120 does not have to be a special ECC memory. The second memory 130 may also be a RAM, a NVRAM, a DIMM, or other forms of memory. The second memory 130 also does not have to be a special ECC memory. Thus, neither the first memory 120 nor the second memory 130 may provide native support for ECC. While first memory 120 and second memory 130 are illustrated as separate physical memories, in one embodiment, first memory 120 and second memory 130 may be separate logical memories that are located in the same physical memory.

Apparatus 100 also includes control logic 140. Control logic 140 functions to control the interface 110 to write a data word to the first memory 120 and to write an ECC word associated with the data word to the second memory 130. In one embodiment, the first memory 120 is accessible via a first data bus and the second memory 130 is accessible via a second, different, data bus. In this embodiment, the data word and the ECC word may be written substantially simultaneously during a single write period.

Apparatus 100 facilitates dynamically reconfiguring a computing system to support ECC, to not support ECC, and to support different types of ECC. Thus, in one embodiment, the first memory 120 may be configured to store data words while the second memory 130 may be configured to store ECC words. In another embodiment, the first memory 120 may be configured to store ECC words while the second memory 130 is configured to store data words. In another embodiment, the first memory 120 may be configured to store both data words and ECC words. Similarly, in one embodiment, the second memory 130 may be configured to store both data words and ECC words while the first memory 120 stores data words. In one embodiment, apparatus 100 may include either or both of the first memory 120 and the second memory 130. One of ordinary skill in the art will appreciate that in one embodiment the ECC word and the data words may be intermingled in two or more memories. Thus, while examples are provided in which the ECC word and data words are stored contiguously, one skilled in the art will appreciate that words may not be stored contiguously.

With these different possible configurations of first memory 120 and second memory 130, the control logic 140 may be configured to selectively control whether the ECC word associated with the data word is written to the second memory 130, whether the ECC word associated with the data word is written to the first memory 120, or whether the ECC word is even written to a memory.

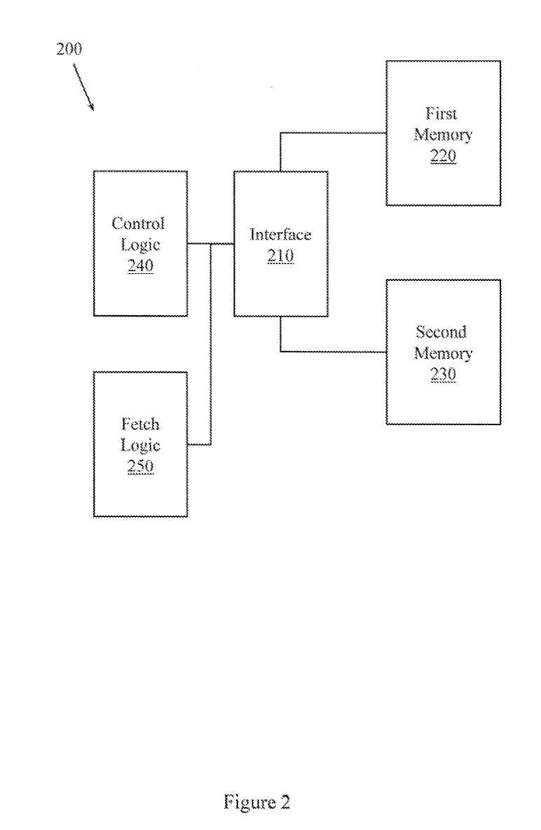

FIG. 2 illustrates an apparatus 200 that includes a control logic 240 operably connected to an interface 210 that is in turn operably connected to a first memory 220 and a second memory 230. The control logic 240, interface 210, and memories 220 and 230 may operate similar to those described in connection with apparatus 100. Apparatus 200 also includes fetch logic 250. Fetch logic 250 functions to control the interface 210 to simultaneously fetch data words from the first memory 220 and ECC words from the second memory 230. In one embodiment, the fetch logic 250 may read a data word from the first memory 220 and an ECC word from the second memory 230 during a single fetch time period. In one embodiment, when both data words and ECC words are written in first memory 220, the fetch logic 250 may still read a data word and an ECC word in a single fetch time period.

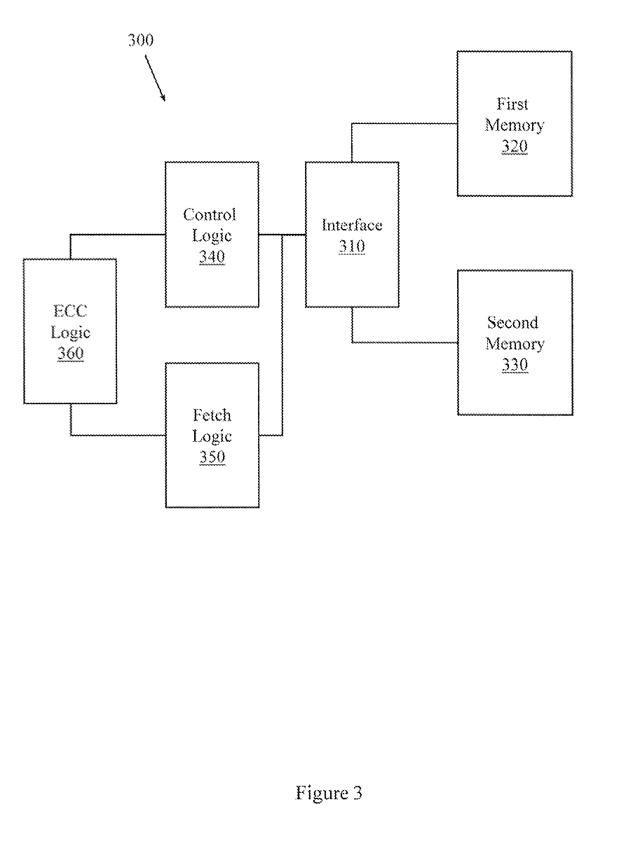

FIG. 3 illustrates an apparatus 300. Apparatus 300 includes a control logic 340 operably connected to an interface 310 that is in turn operably connected to a first memory 320 and a second memory 330. The apparatus 300 also includes a fetch logic 350. The control logic 340, interface 310, fetch logic 350, and memories 320 and 330 may operate similar to those described in connection with apparatus 200. Apparatus 300 also includes ECC logic 360.

ECC logic 360 may be configured to perform ECC processing in hardware in the apparatus 300. The ECC processing may include, for example, both error checking and error correction for the data word and the ECC word. Different approaches to ECC word generation and/or interpretation may be available. Therefore, in one embodiment, ECC logic 360 may be dynamically controllable to perform different ECC approaches available in the ECC logic 360. By way of illustration, a first ECC approach may be available that generates a first type of ECC word that can be interpreted in a first way. A second ECC approach may also be available that generates a second type of ECC word that can be interpreted in a second way. At different times the ECC logic 360 can be dynamically controlled to perform either the first ECC approach or the second ECC approach. The ECC logic 360 may also function to control the ECC word size. The ECC word size may be, for example, a single bit, two bits, 8 bits, 16 bits, and other bit sizes.

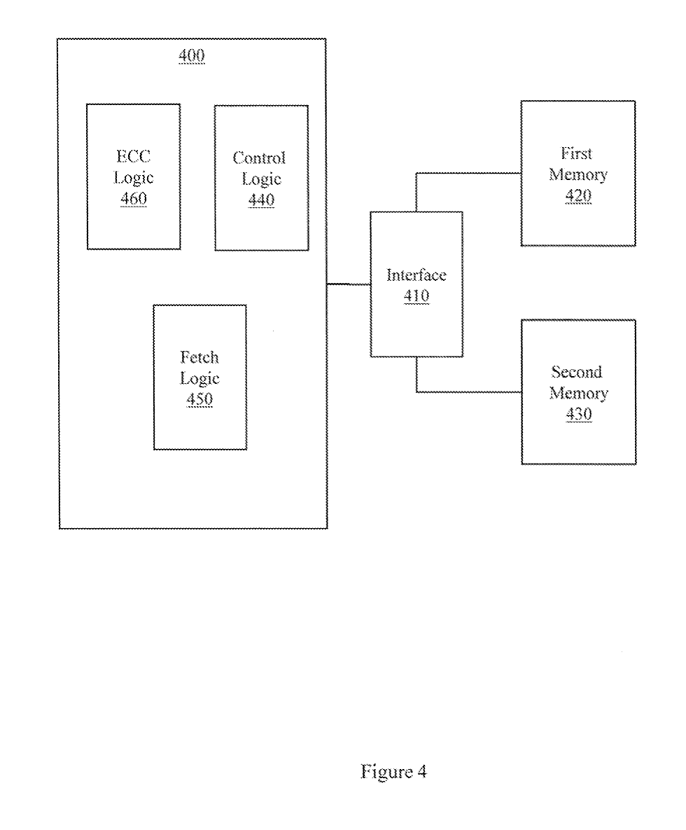

FIG. 4 illustrates a memory controller 400. In different embodiments, elements of apparatus 100 (FIG. 1), apparatus 200 (FIG. 2), and apparatus 300 (FIG. 3) may be implemented in memory controller 400. For example, the memory controller 400 may include a control logic 440, a fetch logic 450, and an ECC logic 460. Memory controller 400 may be connected to a first memory 420 and to a second memory 430 by an interface 410. The interface may be, for example, a bus.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. It is to be appreciated that the methodologies are not limited by the order of the blocks, as some blocks can occur in different orders and/or concurrently with other blocks from that shown and dekribed. Blocks may be combined or separated into multiple components. Furthermore, additional and/or alternative methodologies can employ additional, not illustrated blocks.

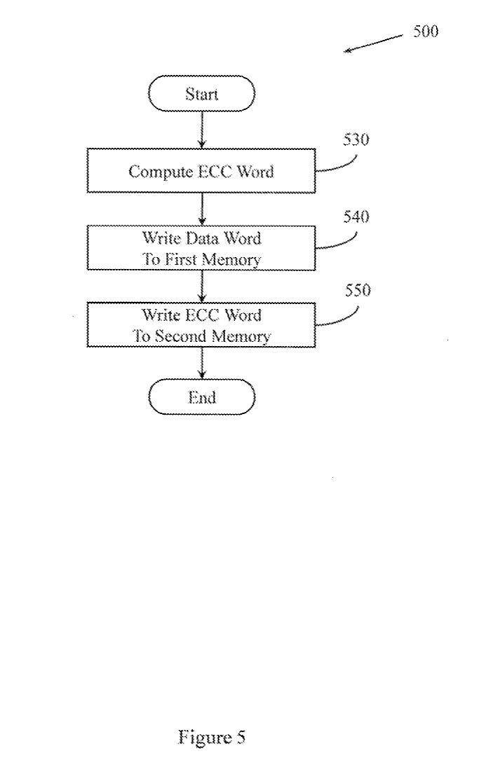

FIG. 5 illustrates an embodiment of a method 500 associated with writing a data word and an ECC word associated with the data word to separate memories. Method 500 includes, at 530, computing, in a hardware circuit, an ECC word associated with a data word. The ECC word may be of different sizes and may be computed according to different protocols. Method 500 also includes, at 540, writing the data word to a first memory and, at 550, writing the ECC word to a second, different memory. One skilled in the art will appreciate that the actions occurring at 540 and 550 will generally occur at the same time. However, in some embodiments, for example when ECC words are cached and/or coalesced before being written to memory, they may occur at different times.

The first memory may be, for example, a RAM, a NVRAM, a DIMM, or other types of memory. The first memory does not have to be a special ECC memory. The second memory may also be a RAM, a NVRAM, a DIMM, or other forms of memory. The second memory also does not have to be a special ECC memory. The first memory and the second memory may be separate physical memories. The first memory and the second memory may also be separate logical memories that are located in the same physical memory.

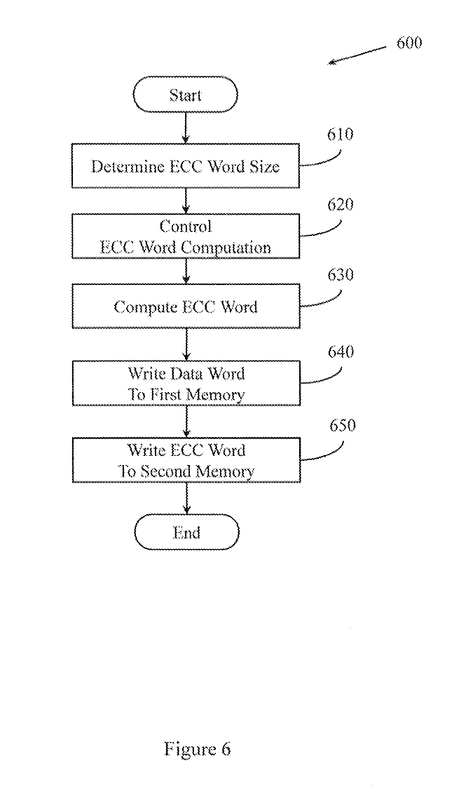

FIG. 6 illustrates a method 600. Method 600 includes some actions similar to those associated with method 500 (FIG. 5). For example, method 600 includes computing an ECC word at 630, writing a data word to a first memory at 640, and writing an ECC word to a second memory at 650. However, method 600 includes some additional actions.

Method 600 includes actions associated with controlling an ECC word size and with controlling how ECC words are computed. Method 600 includes, at 610, selectively determining the ECC word size. The ECC word size may be, for example, 1 bit (or parity), 4 bits, 8 bits, 16 bits, 32 bits, and so on. Since non-ECC memory modules can be employed, the size of the ECC word is not constrained by a module configuration. The ECC word size may be determined dynamically based, for example, on system design, a user input, on a programmatic input, on memory conditions (e.g., memory available), and on other factors. Method 600 also includes, at 620, selectively controlling how an ECC word is computed. An ECC circuit may be able to compute an ECC word according to different protocols. Which protocol is used may be determined dynamically based, for example, on a user input. The different protocols may be wired into an ECC circuit and driven by a control signal.

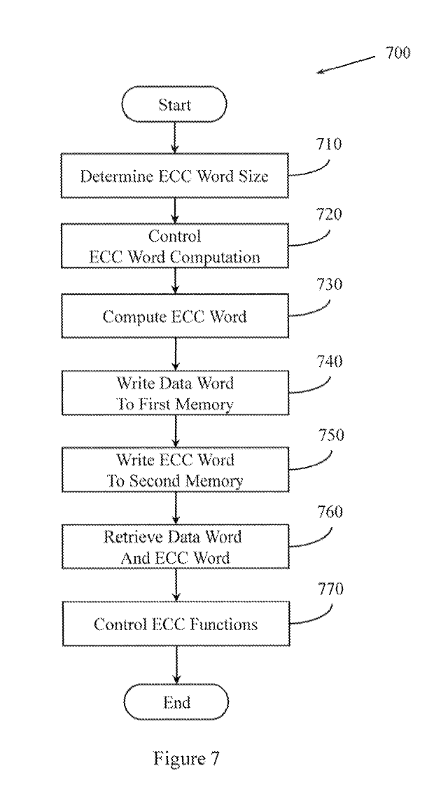

FIG. 7 illustrates a method 700. Method 700 includes some actions similar to those associated with method 600 (FIG. 6). For example, method 700 includes determining an ECC word size at 710, controlling how an ECC word is to be computed at 720, computing an ECC word at 730 based on the determination at 720, writing a data word to a first memory at 740, and writing an ECC word to a second memory at 750. However method 700 includes some additional actions.

Method 700 also includes, at 760, retrieving, in one fetch period, from the first memory and the second memory, both a retrieved data word and a retrieved ECC word. In one example, the first memory and the second memory may be available via different data busses, in which case the one fetch period may include sending separate read control signals to the separate memories over different busses. In another example, the first memory and the second memory may be available via the same data bus. Method 700 also includes, at 770, selectively controlling how an ECC circuit functions to perform error correcting and checking for the retrieved data word in light of the retrieved ECC word. An ECC circuit may include circuitry to evaluate ECC words according to different algorithms or protocols. Which protocol is used may be dynamically selected as a function of, for example, a user input, a programmatic input, a control signal, an interrupt, and other criteria. One skilled in the art will appreciate that, in general, the protocol will match the ECC function that was used when data was written.

Method 700 may also include selectively determining whether to even store or read an ECC word. This facilitates increasing the flexibility of a system over a conventional system that uses special ECC memory. By way of illustration, a computer may at a first time be configured by a method to use the first memory to store data words and to use the second memory to store ECC words. However, at another point in time, the computer may not be interested in using ECC. Therefore, at this other point in time, a method may be used to control the computer to not store ECC words, but rather to use the second memory to store data words.

While FIGS. 5 through 7 illustrate various actions occurring in serial, it is to be appreciated that some actions illustrated in the example methods could occur substantially in parallel. By way of illustration, data words and ECC words will generally be written at the same time. As another illustration, a first process could write data words and related ECC words, a second process could read data words and related ECC words, and a third process could control ECC production and interpretation. While three processes are described, it is to be appreciated that a greater and/or lesser number of processes could be employed.

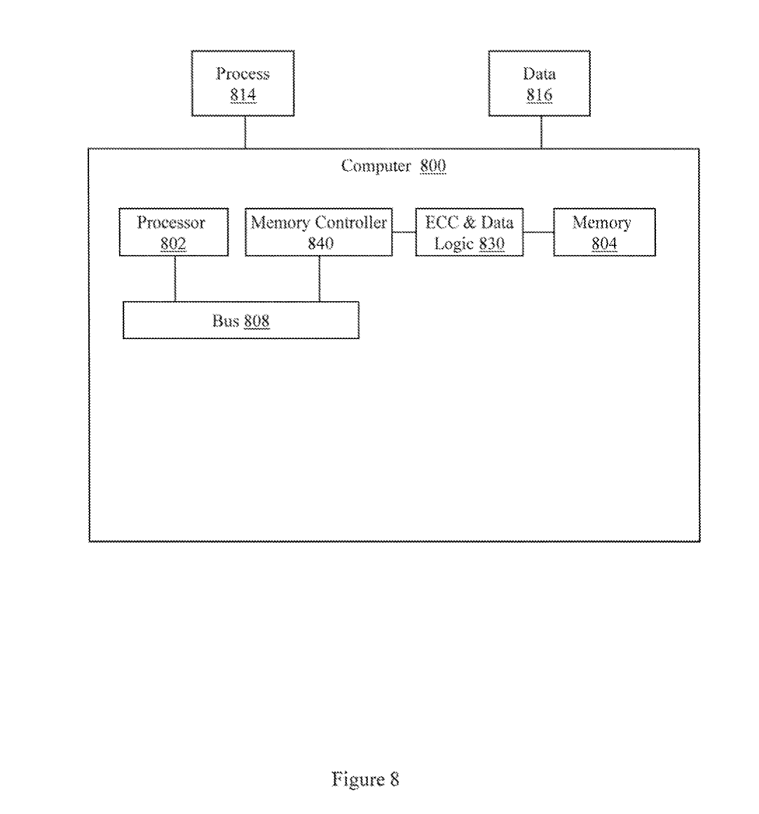

FIG. 8 illustrates a computing environment in which apparatus and methods associated with writing data words and associated error checking and correcting words to different memories may operate. The example computing environment may be a computer 800 that includes a processor 802, and a memory 804 operably connected by a bus 808, through a memory controller 840 and an ECC and data logic 830. The ECC and data logic 830 functions to facilitate writing data words and related ECC words to different memories, reading data words and related ECC words from different memories, controlling ECC word size, controlling ECC word computation, and controlling ECC word interpretation. In different examples, the logic 830 may be implemented in hardware, firmware, and/or combinations thereof. While the logic 830 is illustrated as a hardware component attached to the bus 808, it is to be appreciated that in one example, the logic 830 could be implemented in the processor 802.

Logic 830 may provide means (e.g., hardware, firmware) for accessing a first memory and a second memory that are accessible in one fetch cycle as two separate memories. The memories may be conventional memories and do not have to be special ECC memories. The means may be implemented, for example, as an ASIC. Logic 830 may also provide means (e.g., hardware, firmware) for selectively writing and reading data words in the first memory. Logic 830 may also provide means (e.g., hardware, firmware) for selectively writing and reading ECC words in the second memory, where ECC words in the second memory are related to data words in the first memory.

Generally describing an example configuration of the computer 800, the processor 802 may be a variety of various processors including dual microprocessor and other multi-processor architectures. The memory 804 may include volatile memory and/or non-volatile memory.

The bus 808 may be a single internal bus interconnect architecture and/or other bus or mesh architectures. While a single bus is illustrated, it is to be appreciated that the computer 800 may communicate with various devices, logics, and peripherals using other busses (e.g., PCIE, 1394, USB, Ethernet). The bus 808 can be types including, for example, a memory bus, a memory controller, a peripheral bus, an external bus, a crossbar switch, and/or a local bus.

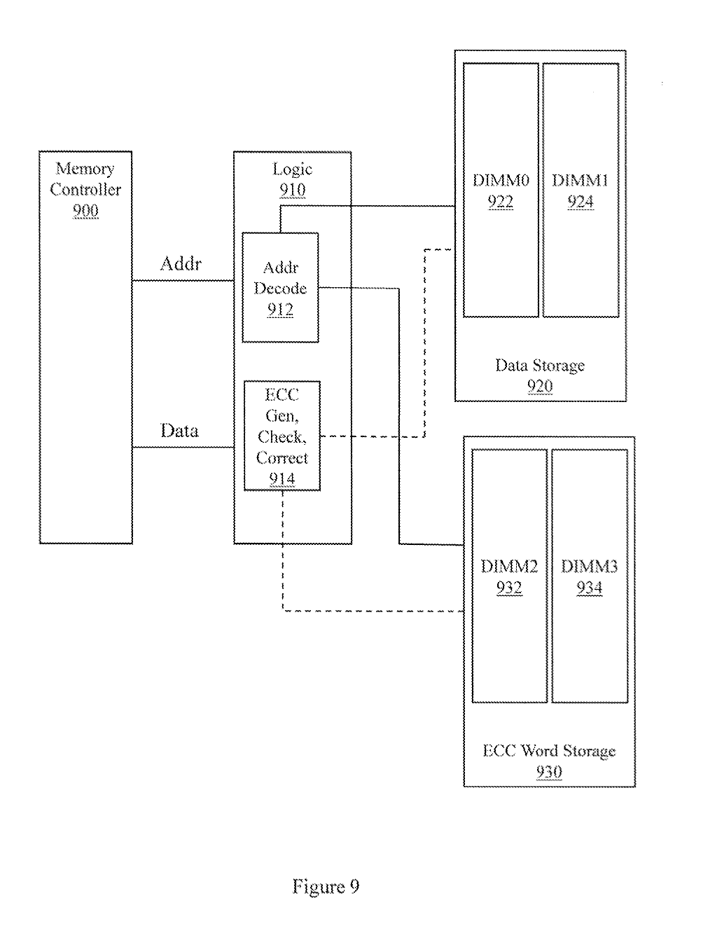

FIG. 9 illustrates a memory controller 900 connected to a logic 910. Logic 910 includes an address decode logic 912 and an ECC logic 914 that performs ECC generation, checking, and correcting. The memory controller 900 provides addresses and data to logic 910. Logic 910 is connected to a data storage 920 and to an ECC word storage 930. The data storage 920 may include, for example, a DIMM0 922 and a DIMM1 924. The DIMMs do not need to support ECC. The ECC word storage 930 may include a DIMM2 932 and a DIMM3 934. The DIMMs again do not need to support ECC. While two DIMMs are illustrated in each of the data storage 920 and the ECC word storage 930, one skilled in the art will appreciate that different numbers and types of DIMMs may be used. One skilled in the art will appreciate that different address and ECC information may be provided to the data storage 920 and to the ECC word storage 930. The arrangement of components illustrated in FIG. 9 facilitates writing data words and associated ECC words to different memories, where the facilitating occurs outside memory controller 900.

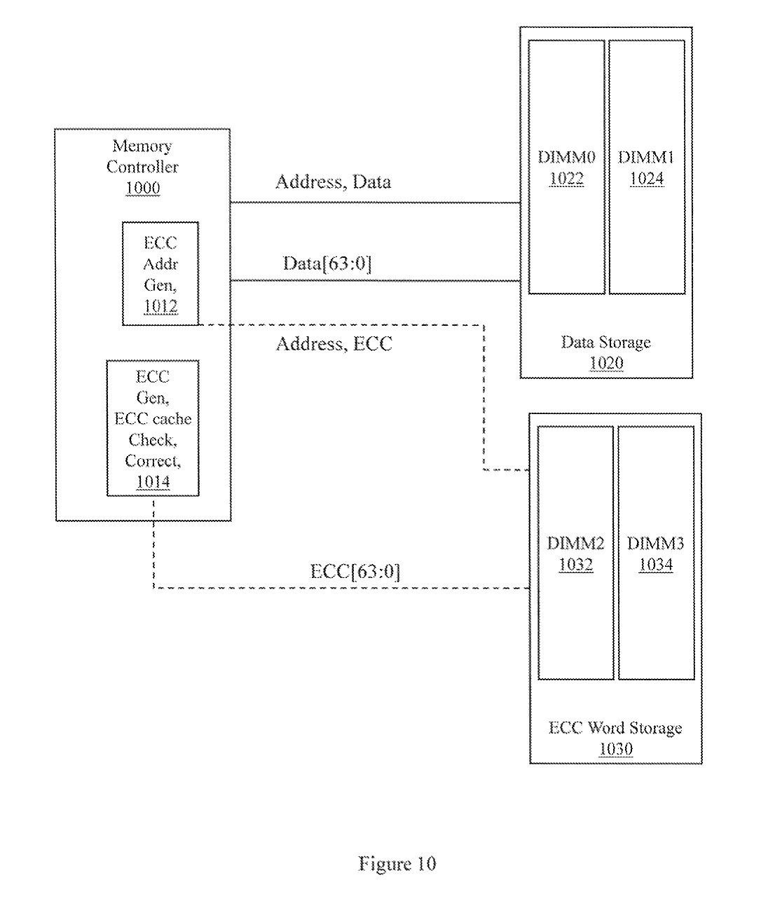

FIG. 10 illustrates a memory controller 1000 that has a logic 1012 that performs ECC address generation. Memory controller 1000 also includes a logic 1014 that performs ECC generation, ECC caching (to optimize writing/coalescing of ECC words), checking, and correcting. Memory controller 1000 is connected to a data storage 1020 and to an ECC word storage 1030. The data storage 1020 may include, for example, a DIMM0 1022 and a DIMM1 1024. The DIMMs may or may not support ECC. The ECC word storage 1030 may include a DIMM2 1032 and a DIMM3 1034. Again, the DIMMs do not need to support ECC, but might. One skilled in the art will appreciate that different address information and ECC information may be provided to the data storage 1020 and to the ECC word storage 1030. The arrangement of components illustrated in FIG. 10 facilitates writing data words and associated ECC words to different memories, where the facilitating occurs inside memory controller 1000.

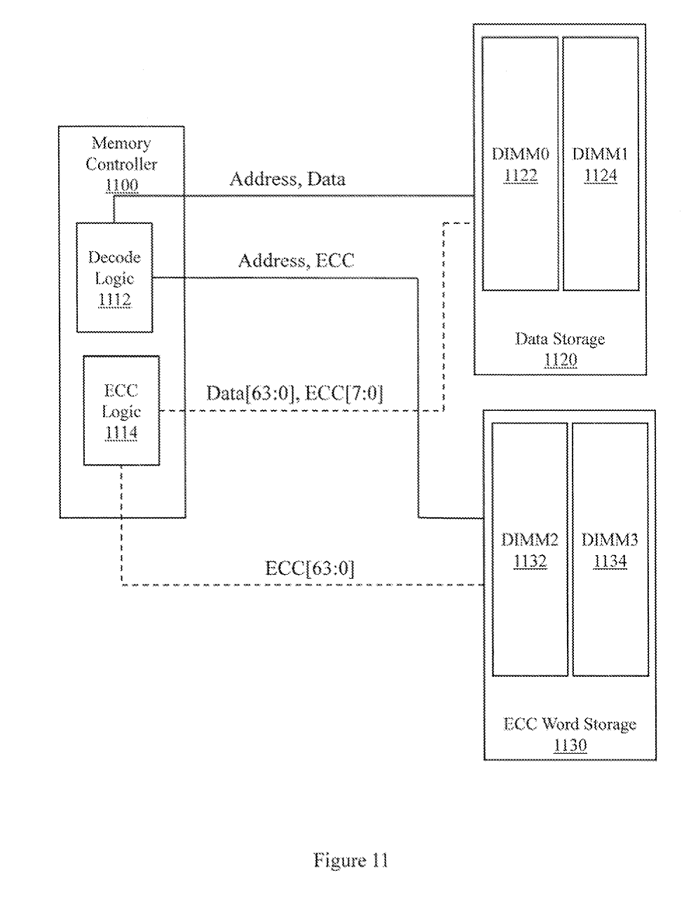

FIG. 11 illustrates an arrangement of components that support use of an ECC DIMM. In this arrangement, bits from the data storage 1120 can be used to store additional ECC bits instead of storing data. In one example, the extra bits may facilitate extending the protection afforded to an ECC DIMM. The extended protection may support, for example, single chip-spare, double chip-spare, and so on. “Chip spare” is a term used to describe the ability of an ECC algorithm to tolerate a single memory device failure and yet to still provide correct data. The number of chips that can be spared will vary with the device size (e.g., how many bits of data provided per ECC word) and the strength of the ECC algorithm (e.g., the number of bits of ECC, the exact algorithm, and so on). For example, for a DIMM composed of x4 DRAM devices that provide 4 bits of data, a single chip spare ECC algorithm would need to allow 4 bits to fail per access of that device. But if an x8 DRAM device that provided 8 bits of data failed, a single chip spare ECC algorithm would need to tolerate 8 bits failing per access. As a result, as memory device width increases, more ECC bits are needed to tolerate a failure.

Memory controller 1100 includes an address decode logic 1112 and an ECC logic 1114 that can perform ECC generation, checking, and correcting. Memory controller 1100 is connected to a data storage 1120 that includes DIMM0 1122 and DIMM1 1124. Memory controller 1100 is also connected to an ECC word storage 1130 that includes DIMM2 1132 and DIMM3 1134. One skilled in the art will appreciate that different address information and ECC information may be provided to the data storage 1120 and the ECC word storage 1130.

Another alternative associated with FIG. 11 concerns data being stored both in the data storage 1120 and the ECC word storage 1130, with ECC being stored in the ECC word storage 1130 as well as data (or vice versa). Additionally, one of ordinary skill in the art will appreciate that ECC and data may be intermixed between 1120 and 1130. This allows a system designer the ability to store extra data in memory as compared to a single DIMM and yet get better ECC protection than before. One example DDR[123] ECC DIMM has 64 bits of data+8 bits of ECC (or 72 bits total). Two DIMMs provide 144 bits of data+ECC. One example implementation is to store 8 bits of ECC per DIMM, or 128 bits of data and 16 bits of ECC. Using example systems and methods described herein facilitates storing 24 bits of ECC and 120 bits of data for applications that need more protection. Conversely the amount of ECC protection could be reduced to store more data. Using the same example, 8 bits of ECC and 136 bits of data could be stored.

As shown above, the systems and methods described herein provide a system designer or end user with flexibility in how they would like to trade off error correction strength, data, and cost. Using FIG. 11 as an example, one could store data across data storage 1120 as well as part of the ECC word storage 1130. For example, assuming DDR[123] ECC DIMMs, data storage 1120 could store 72 bits of data and ECC word storage 1130 could store 40 bits of data with 32 bits of ECC being stored in 1130 along with the data.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. An apparatus, comprising:
an interface to a first memory and to a second memory; and
a control logic that functions to control the interface to write a data word to the first memory and to write an error checking and correcting (ECC) word associated with the data word to the second memory.

2. The apparatus of claim 1, comprising:
a fetch logic that functions to control the interface to simultaneously fetch the data word from the first memory and the ECC word from the second memory during a single fetch time period.

3. The apparatus according to claim 1, comprising:
an ECC logic configured to perform, in hardware in the apparatus, error checking and correction for the data word and the ECC word according to one of a plurality of ECC approaches available in the ECC logic, an ECC approach being dynamically selectable.

4. The apparatus according to claim 1, the first memory being accessible via a first data bus and the second memory being accessible via a second, different, data bus.

5. The apparatus of claim 3, where the ECC logic functions to control an ECC word size.

6. The apparatus according to claim 1, the control logic being configured to selectively control whether the ECC word associated with the data word is written to the second memory.

7. The apparatus according to claim 1, comprising the first memory and the second memory, the first memory being one of, a RAM, an NVRAM, a DIMM, and a memory structure, the second memory being one of, a RAM, an NVRAM, a DIMM, and a memory structure, and where at least one of, the first memory, and the second memory do not provide native ECC support.

8. The apparatus according to claim 1, the control logic being configured to support one or more of, single chip-spare, and double chip-spare by selectively extending ECC bits provided by a first ECC DIMM with additional bits from a second DIMM.

9. The apparatus according to claim 1, the apparatus being implemented in a memory controller.

10. The apparatus according to claim 1, the first memory being configured to store one of, only data words, and both data words and ECC words, the second memory being configured to store one of, only ECC words, and both ECC words and data words.

11. A method, comprising:
computing, in a hardware circuit, an error checking and correcting (ECC) word associated with a data word;
writing the data word to a first memory; and
writing the ECC word to a second, different memory.

12. The method of claim 11, comprising:
selectively determining the size of the ECC word; and
selectively controlling how the circuit functions to compute the ECC word.

13. The method according to claim 11, comprising:
retrieving, in one fetch period, from the first memory and the second memory, both a retrieved data word and a retrieved ECC word; and
selectively controlling how the circuit functions to perform error checking and correcting for the retrieved data word based on the retrieved ECC word.

14. The method according to claim 11, comprising:
selectively determining whether to use the second memory to store data words.

15. A system, comprising:
means for accessing a first memory and a second memory that are accessible in one fetch cycle as two separate memories;
means for selectively writing and reading data words in the first memory; and
means for selectively writing and reading ECC words in the second memory, where ECC words in the second memory are related to data words in the first memory.
